(19) United States
(12) Patent Application Publication
(10) Pub. No.: US 2008/0071914 A1
(43) Pub. Date: Mar. 20, 2008

(54) SESSION CONTROL SYSTEM

(75) Inventors: Motonobu Kimura, Minato-ku (JP); Masashi Tanaka, Minato-ku (JP); Kaname Naito, Minato-ku (JP); Takashi Okazaki, Minato-ku (JP); Shuhei Miura, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku (JP)

(21) Appl. No.: 11/857,153

(22) Filed: Sep. 18, 2007

(30) Foreign Application Priority Data
Sep. 20, 2006 (JP) 2006-254245

(51) Int. Cl. G06F 15/173

(52) U.S. Cl. 709/228

(57) ABSTRACT

A first session proxy device is disposed between a client device having no control protocol for bandwidth securing sessions installed therein and a bandwidth guaranteed network. A second session proxy device is disposed between a server device having no control protocol for bandwidth securing sessions installed therein and the bandwidth guaranteed network. When the client device and the server perform communication over the bandwidth guaranteed network, the first session proxy device establishes a bandwidth securing session in the bandwidth guaranteed network, in place of the client device, while second session proxy device establishes a bandwidth securing session in the bandwidth guaranteed network, in place of the server device.

This application is based upon and claims the benefit of priority from Japanese Patent Application No. 2006-254245 filed on Sep. 20, 2006, the content of which is incorporated by reference.

### BACKGROUND OF THE INVENTION

1. Field of the Invention

The present invention relates to client-server communication in a packet-based communication network.

2. Description of the Related Art

In recent years, studies on the next generation communications network utilizing IP(Internet Protocol) technology to be provided by telecommunications carriers have been extensively carried out. The next generation communications network is called NGN (Next Generation Network) or the like (ITU-T recommendation Y. 2001[December 2004] see “General overview of NGN”). The NGN is expected to achieve cost reduction of public networks by use of IP technology.

The facilities for standardization, namely, ETSI(European Telecommunications Standards Institute), ITU-T (International Telecommunication Union Telecommunication Standardization Sector) have been making progress in standardizing protocols in order to realize this next generation communications network.

The existing IP networks represented by the Internet have a cost advantage but there is anxiety in terms of communication stability and reliability. For example, there is a higher risk of data delay and loss occurring compared to the public networks provided by telecommunication carriers. However, both low cost and communication stability and reliability are expected and demanded for next generation networks that will be offered by telecommunications carriers.

One of the causes that gives rise to data delay and loss can be considered to be that the bandwidth required for stable communication can not be always secured in IP networks. To deal with this, the next generation networks often adopt a method of communication whereby a session is established first between a server and a client with whom communication will take place, and then the bandwidth is managed for every session. Establishment of this session is permitted on the condition that the necessary bandwidth is secured. Thus, the necessary bandwidth is assured between the server and client, with whom a session has been established, so that it is possible to achieve stable communication. As one example of the session control protocols to be used in next generation communication networks to secure the necessary bandwidth, SIP (session Initiation Protocol) can be listed.

In order to perform such bandwidth management, it is possible that a session controller for managing allocation of a bandwidth to each session will be provided for next generation networks. A server and a client establish a session after getting permission from such a session controller, so that it becomes possible to receive and transmit data in a stable manner within the permitted bandwidth.

The above-described technology, however, has the following problem.

There are cases in which, in order to transmit and receive data on a bandwidth guaranteed network that secures the bandwidth for the communication between a server and a client by establishment of a session, the server and client need to include a session control protocol. However, of the information communicating devices such as existing servers and clients, there are those which have no such a session control protocol. As a result, there is a possibility that such information communicating devices cannot support communication whose bandwidth is secured by such a session.

### SUMMARY OF THE INVENTION

An exemplary object of the invention is to provide a system and a device which, on a bandwidth guaranteed network that secures a bandwidth for client-server communication by establishment of a session, enables communicating devices having no session control protocol for securing a bandwidth to perform bandwidth-secured communication therebetween.

In order to achieve the above object, an exemplary aspect of the invention is a session control system which controls a bandwidth securing session on a bandwidth guaranteed network in which bandwidth-secured packet-based communication is enabled by management of the band securing session, and includes a first session proxy device and a second session proxy device.

The first session proxy device is disposed between a client device not having a control protocol for bandwidth securing sessions installed therein and a bandwidth guaranteed network. In place of the client device the first session proxy device establishes a bandwidth securing session in the bandwidth guaranteed network when the client device performs communication over the bandwidth guaranteed network.

The second session proxy device is disposed between a server device having no control protocol for bandwidth securing sessions installed therein and the bandwidth guaranteed network. In place of the server device, the second session proxy device establishes a bandwidth securing session with the first session proxy device when the server device performs communication over the bandwidth guaranteed network.

The above and other objects, features, and advantages of the present invention will become apparent from the following description with references to the accompanying drawings which illustrate examples of the present invention.

### BRIEF DESCRIPTION OF THE DRAWINGS

FIG. 1 is a block diagram showing a communication system configuration according to an exemplary embodiment;

FIG. 2 is a sequence chart showing the overall operation of a communication system according to an exemplary embodiment;

FIG. 3A is a first sequence chart showing the operation of a communication system when a SIP session is used as a bandwidth securing session;

FIG. 3B is a second sequence chart showing the operation of a communication system when a SIP session is used as a bandwidth securing session;

FIG. 3C is a third sequence chart showing the operation of a communication system when a SIP session is used as a bandwidth securing session; and,

FIG. 4 is a block diagram showing a configuration of session proxy device 12 deployed on the client 11 side and a configuration of session proxy device 13 deployed on the APL server 14 side.

### DESCRIPTION OF THE PREFERRED EMBODIMENT

A mode for carrying out the exemplary embodiment will be described in detail with reference to the drawings.

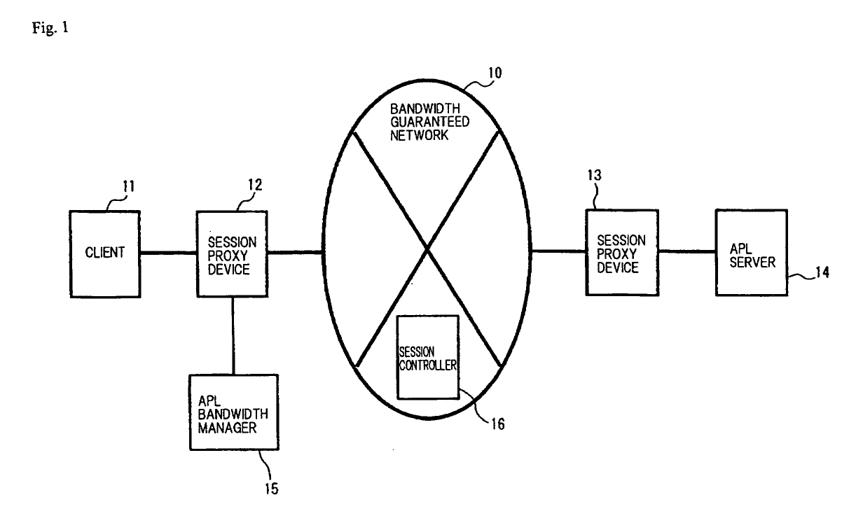

FIG. 1 is a block diagram showing a configuration of a communication system according to the exemplary embodiment. Referring to FIG. 1, the communication system of this exemplary embodiment includes bandwidth guaranteed network 10, client 11, session proxy devices 12 and 13, application (APL) server 14 and application (APL) bandwidth manager 15. Bandwidth guaranteed network 10 incorporates session controller 16.

Bandwidth guaranteed network 10 is an IP network that is offered by a telecommunications carrier, and is a communication network that enables bandwidth secured communication. The bandwidth between client 11 and APL server 14 in bandwidth guaranteed network 10 is secured when session proxy devices 12 and 13 establish a session after gaining a permission from session controller 16 inside bandwidth guaranteed network 10. In bandwidth guaranteed network 10, SIP, for example is used as the control protocol for bandwidth securing sessions.

Session controller 16 manages the allocation of bandwidth resources on bandwidth guaranteed network 10, and when receiving a request for securing a bandwidth from session proxy devices 12 and 13, the controller determines whether the request can be accepted or not based on the allocation status of bandwidth resources. If the request is accepted, a bandwidth securing session is established whereas no bandwidth securing session is established if the request is not accepted.

APL server 14 is a server device for offering an application service to client 11 by way of bandwidth guaranteed network 10. APL server 14, in response to a request from client 11, offers an application service to client 11. Examples of applications include on-demand contents distribution and exchange of files based on FTP. APL server 14 has no control protocol (SIP herein is one of the examples) for controlling bandwidth securing sessions on bandwidth guaranteed network 10.

Client 11 is a client device for utilizing an application presented by APL server 14. Client 11 accesses to APL server 14 to request an application service. Similarly to APL server 14, client 11 has no control protocol for controlling bandwidth securing sessions on bandwidth guaranteed network 10.

When an application service is offered from APL server 14 to client 11, both client 11 and APL server 14 establish a session (to be referred to hereinbelow as a “session for applications”) therebetween to be used for presenting an application. This session for applications is controlled by a control protocol that is different from that for bandwidth securing sessions. The control protocol of the session for applications is installed beforehand in both APL server 14 that presents applications and client 11 that uses applications.

Session proxy devices 12 and 13 establish a session in place of client 11 and APL server 14, which include no control protocol for bandwidth securing sessions, to secure the bandwidth. For this purpose, session proxy devices 12 and 13 have been installed with a control protocol for bandwidth securing sessions. When session proxy device 12 establishes a bandwidth securing session, it acquires the necessary bandwidth information from APL bandwidth manager 15.

APL bandwidth manager 15 is a device for managing the bandwidth that will be needed for the application service presented by APL server 14. APL bandwidth manager 15 has bandwidth management data that was recorded to represent the correspondence between the types of applications and the bandwidths to be secured for those applications, stored beforehand. When receiving an inquiry about the necessary bandwidth for an application, APL bandwidth manager 15 searches for the necessary bandwidth from the bandwidth management data in answer to the query, and gives back the necessary bandwidth information.

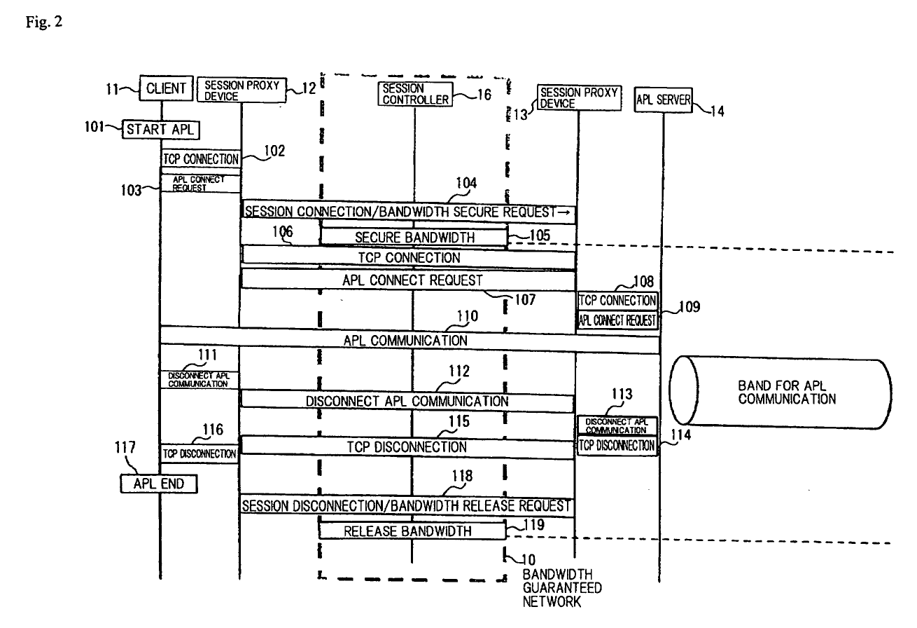

FIG. 2 is a sequence chart showing the overall operation of a communication system according to an exemplary embodiment.

Referring to FIG. 2, when an application is started in client 11 (Step 101), client 11 sets up a TCP connection with session proxy device 12 (Step 102). When a TCP connection has been established between client 11 and session proxy device 12, client 11 sends an application connect request to session proxy device 12 (Step 103). This application connect request is to request establishment of a session for applications, and contains connection target information showing connection target APL server 14. From this connection target information, session proxy device 13 to which a bandwidth securing session should be established, can be known.

Upon receiving an application connect request, session proxy device 12 holds it and establishes a bandwidth securing session with session proxy device 13 and executes a bandwidth securing process (Step 104). As a result of this process, a bandwidth securing session with the necessary bandwidth secured is established between session proxy device 12 and session proxy device 13 (Step 105).

Subsequently, session proxy device 12 sets up a TCP connection with session proxy device 13 (Step 106). As a TCP connection has been established between session proxy device 12 and session proxy device 13, session proxy device 12 sends the application connect request that was received from client 11 at Step 103 (Step 107).

Then, session proxy device 13 sets up a TCP connection with APL server 14 (Step 108). As a TCP connection has been established between session proxy device 13 and APL server 14, session proxy device 13 sends the application connect request received at Step 107 to APL server 14 (Step 109).

After this condition is met, the bandwidth securing session with the necessary bandwidth secured between session proxy device 12 and session proxy device 13 is established while a session for applications is established between client 11 and server 14. Accordingly, it is possible for client 11 and server 14 to perform stable application communication therebetween with the bandwidth secured (Step 110).

When the service is ended after the application communication is completed, client 11 disconnects the application communication between client 11 and APL server 14 (Steps 111 to 113).

Then, APL server 14 disconnects the TCP connection with session proxy device 13 (Step 114). Session proxy device 13 disconnects the TCP connection with session proxy device 12 (Step 115). Session proxy device 12 disconnects the TCP connection with client 11 (S116).

As the TCP connection between client 11 and session proxy device 12 is disconnected, the application terminates at client 11 (step 117).

Also, session proxy device 12 performs a process of cutting the bandwidth securing session with session proxy device 13 (Step 118). This process frees the bandwidth having been secured between session proxy device 12 and session proxy device 13 (Step 119).

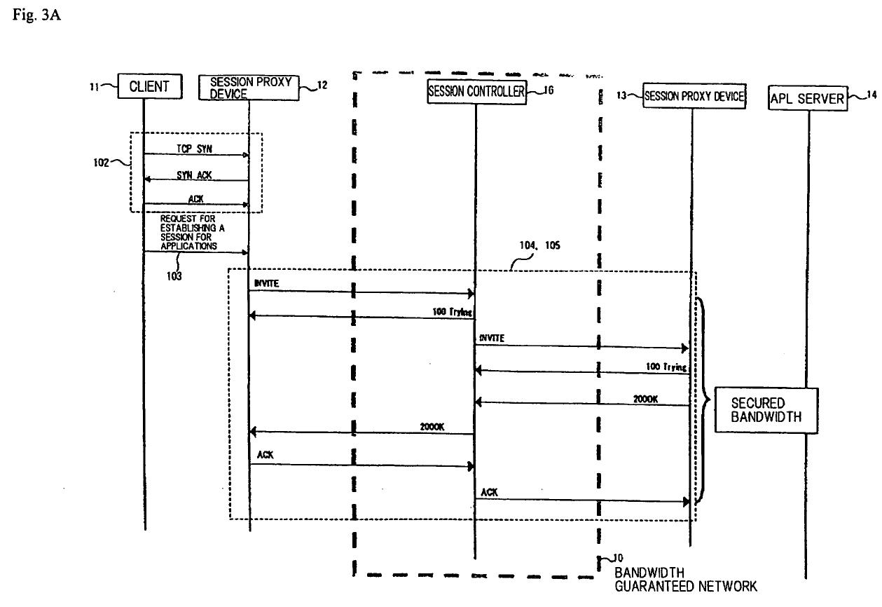

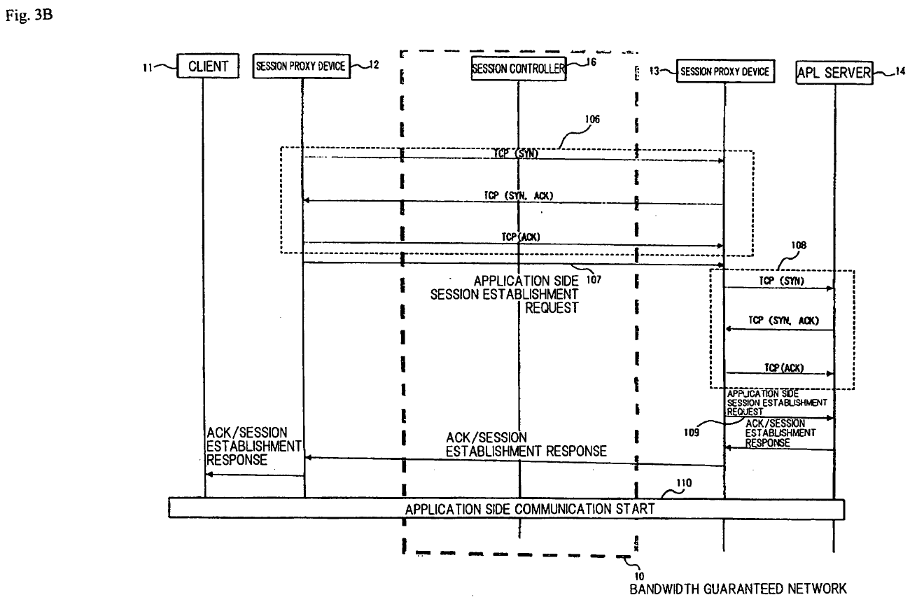

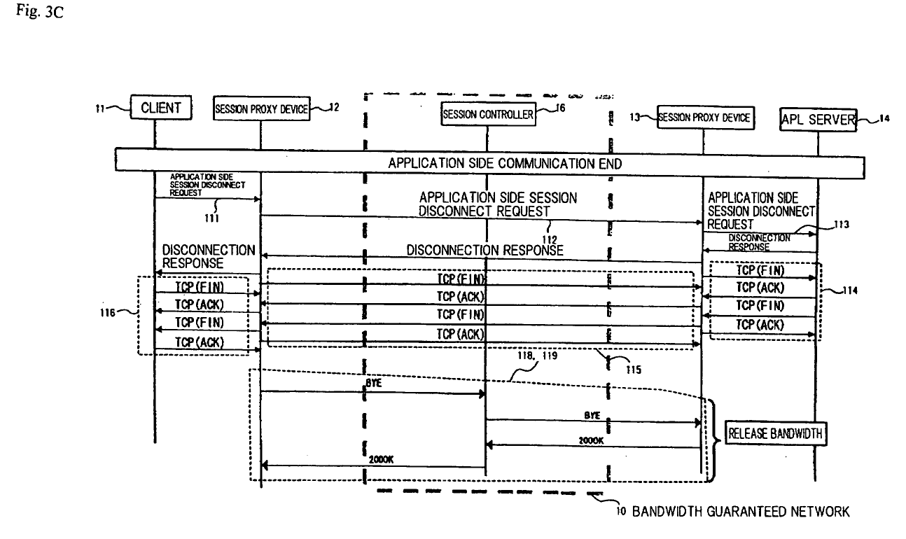

FIGS. 3A to 3C are sequence charts showing the operations of a communication system when a SIP session is used for a bandwidth-securing session.

Referring to FIG. 3A, in the TCP connecting process at Step 102 in FIG. 2, “SYN” is transmitted from client 11 to session proxy device 12, and “SYN ACK” is sent from session proxy device 12 to client 11, then “ACK” is returned from client 11 to session proxy device 12.

In the process of establishing a SIP session at Steps 104 and 105 in FIG. 2, “INVITE” is sent from session proxy device 12 to session controller 16 in order to request establishment of a SIP session, and “100 Trying” that indicates trying in progress is returned from session controller 16 to session proxy device 12. “INVITE” and “200 OK” corresponding to “INVITE” contain SDP that describes the parameters indicating the request content. Then, “INVITE” is sent from session controller 16 to session proxy device 13, and “100 Trying” is returned from session proxy device 13 to session controller 16.

Subsequently, “200 OK” that indicates acceptance of the request is sent from session proxy device 13 to session controller 16. Also, “200 OK” is sent from session controller 16 to session proxy device 12. In response to this, “ACK” that indicates an understanding is sent from session proxy device 12 to session controller 16, and “ACK” is sent from session controller 16 to session proxy device 13.

Referring to FIG. 3B, in the TCP connecting process at Step 106 in FIG. 2, “SYN” is sent from session proxy device 12 to session proxy device 13, and “SYN ACK” is sent from session proxy device 13 to session proxy device 12, then “ACK” is returned from session proxy device 12 to session proxy device 13.

Also, in the TCP connecting process at Step 108 in FIG. 2, “SYN” is sent from session proxy device 13 to APL server 14, and “SYN ACK” is sent from APL server 14 to session proxy device 13, then “ACK” is returned from session proxy device 13 to APL server 14.

Referring to FIG. 3C, in the TCP disconnecting process at Step 114 in FIG. 2, “FIN” is sent from session proxy device 13 to APL server 14, and “ACK” is sent back from APL server 14 to session proxy device 13. Also, “FIN” is sent from APL server 14 to session proxy device 13, then “ACK” is returned from session proxy device 13 to APL server 14.

Also, in the TCP disconnecting process at Step 115 in FIG. 2, “FIN” is sent from session proxy device 12 to session proxy device 13, and “ACK” is sent back from session proxy device 13 to session proxy device 12. Also, “FIN” is sent from session proxy device 13 to session proxy device 12, then “ACK” is returned from session proxy device 12 to session proxy device 13.

Further, in the TCP disconnecting process at Step 116 in FIG. 2, “FIN” is sent from client 11 to session proxy device 12, and “AC K” is sent back from session proxy device 12 to client 11. Also, “FIN” is sent from session proxy device 12 to client 11, then “ACK” is returned from client 11 to session proxy device 12.

Next, in the SIP session freeing process at Steps 118 and 119 in FIG. 2, “BYE” that requests the release of the SIP session is sent from session proxy device 12 to session controller 16. Likewise, “BYE” is sent from session controller 16 to session proxy device 13. In response to this, “200 OK” is sent back from session proxy device 13 to session controller 16, and “200 OK” is sent back from session controller 16 to session proxy device 13.

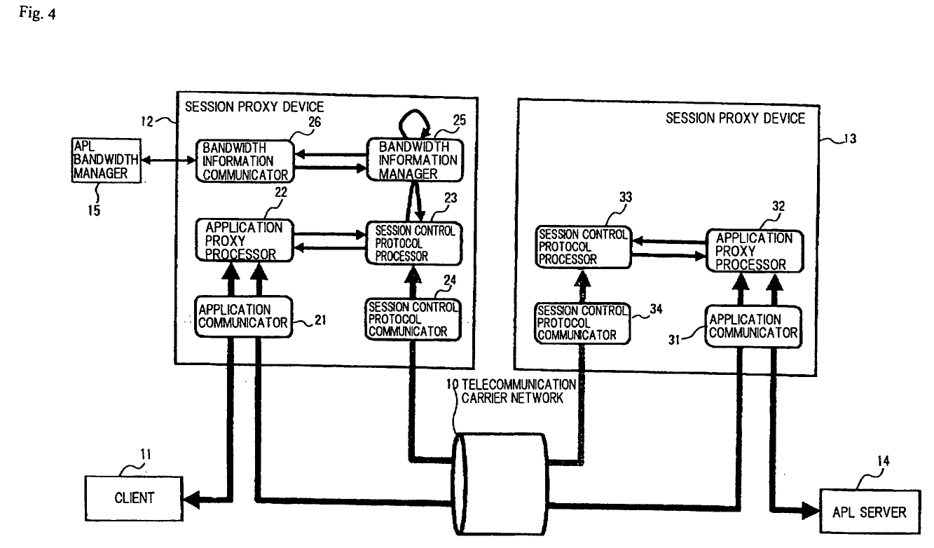

FIG. 4 is a block diagram showing a configuration of session proxy device 12 deployed on the client 11 side and a configuration of session proxy device 13 deployed on the APL server 14 side.

Referring to FIG. 4, session proxy device 12 on the client 11 side includes application communicator 21, application proxy processor 22, session control protocol processor 23, session control protocol communicator 24, bandwidth information manager 25 and bandwidth information communicator 26.

Application communicator 21 relays and transfers the data that is exchanged between client 11 and APL server 14.

Session control protocol communicator 24 exchanges control signals, based on the control protocol for bandwidth securing sessions, with bandwidth guaranteed network 10, in accordance with the instructions from session control protocol processor 23.

Bandwidth information manager 25 acquires the information on the bandwidth to be secured for applications, from APL bandwidth manager 15 by way of bandwidth information communicator 26. Though it is specified herein that bandwidth information manager 25 acquires the information on the bandwidth from APL bandwidth manager 15, the invention should not be limited to this. As another example, bandwidth information manager 25 may, by itself, have the bandwidth management data, which was recorded to represent the relationship between the types of applications and the bandwidths to be secured for those applications, stored beforehand. In this case, if bandwidth information manager 25 receives an inquiry about the bandwidth for the designated application type, from session control protocol processor 23, the manager may determine the information on the bandwidth to be secured for the application based on its own bandwidth management data and respond to session control protocol processor 23. As a still another example, the application connect request from client 11 may be adapted to contain the bandwidth information that shows the necessary bandwidth. In this case, bandwidth information manager 25 may determine the bandwidth to be secured for the application, based on the bandwidth information contained in the application connect request.

Bandwidth information communicator 26 communicates with APL bandwidth manager 15 following instructions from bandwidth information manager 25 to make an inquiry, and bandwidth information communicator 26 may acquire the information on the bandwidth to be secured for the application.

Application proxy processor 22 monitors the data that is being relayed and transferred by application communicator 21, and gives a notice to session control protocol processor 23 if there is a request for connection or disconnection of an application.

When a request for establishment of a session for applications is made from client 11 to APL server 14, application proxy processor 22 temporarily holds the request instead of transmitting it to APL server 14 and informs session control protocol processor 23 of the fact of reception of the application connect request. This information contains the information representing the type of the application. Then, upon receiving the notice from session control protocol processor 23, indicating that a bandwidth securing session has been established, the processor 22 transmits the request for establishment of a session for applications, which has been retained, to APL server 14 by way of bandwidth guaranteed network 10.

On the other hand, when a request for disconnection of a session for applications is made from client 11 to APL server 14, application proxy processor 22 sends the request to APL server 14 and then notifies session control protocol processor 23 of the fact of reception of the application disconnect request.

Session control protocol processor 23 has a session control protocol function for bandwidth securing sessions, and in accordance with the notice from application proxy processor 22, establishes or disconnects a bandwidth securing session with session proxy device 13 on the APL server 14 side by way of session control protocol communicator 24. The bandwidth securing session is established with the condition that permission is obtained from session controller 16 or in one word, that the bandwidth has been secured.

Upon receiving a notice that indicates reception of an application connect request from application proxy processor 22, session control protocol processor 23 executes a process of establishing a bandwidth securing session with session proxy device 13 on the APL server 14 side. During this process, session control protocol processor 23 acquires the information on the bandwidth to be secured for the application communication, from bandwidth information manager 25. Then, as the bandwidth securing session through the secured bandwidth has been established, session control protocol processor 23 notifies application proxy processor 22 of the fact that the bandwidth securing session has been established.

When receiving a notice that indicates reception of an application disconnect request from application proxy processor 22, session control protocol processor 23 executes a process of disconnecting the bandwidth securing session with session proxy device 13 on the APL server 14 side.

Referring once again to FIG. 4, session proxy device 13 on the APL server 14 side includes application communicator 31, application proxy processor 32, session control protocol processor 33 and session control protocol communicator 34.

Application communicator 31 relays and transfers the data that is exchanged between APL server 14 and client 11.

Session control protocol communicator 34 exchanges control signals based on the control protocol for bandwidth securing sessions, with bandwidth guaranteed network 10, in accordance with the instructions from session control protocol processor 33.

Application proxy processor 32 monitors the data that is being relayed and transferred by application communicator 31, and gives a notice to session control protocol processor 33 if there is a message relating to connection or disconnection of an application.

Session control protocol processor 33 has a session control protocol function for bandwidth securing sessions, and in accordance with a request from session proxy device 12 on the client 11 side, establishes or disconnects a bandwidth securing session with session proxy device 12 by way of session control protocol communicator 24.

As has been described above, according to the exemplary embodiment, since session proxy device 12, in place of client 11, and session proxy device 13, in place of APL server 14, control the establishment and disconnection of a bandwidth securing session so as to maintain and free the bandwidth for application communication between client 11 and APL server 14, it is possible to achieve bandwidth secured communication even if client 11 and APL server 14 have no control protocol for bandwidth securing sessions installed therein.

Further, according to the exemplary embodiment, since session proxy device 12 first checks the bandwidth that is needed for the application that will be used by client 11, and then secures the necessary bandwidth, it is possible to secure the bandwidth that is needed by the application communication.

It should be noted that session proxy device 12 and session proxy device 13 in the exemplary embodiment may be realized by a computer, which has the programs for executing the functions of the individual components shown in FIG. 4, stored in memory, and which executes the programs by using its processor.

While preferred embodiments of the present invention have been described using specific terms, such description is for illustrative purposes only, and it is to be understood that changes and variations may be made without departing from the spirit or scope of the following claims.

What is claimed:

1. A session control system which controls a bandwidth securing session on a bandwidth guaranteed network in which bandwidth-secured packet-based communication is enabled by management of the band securing session, comprising:
a first session proxy device which is disposed between a client device not having a control protocol for bandwidth securing sessions installed therein and said bandwidth guaranteed network and which establishes a bandwidth securing session in said bandwidth guaranteed network, in place of said client device when said client device performs communication over said bandwidth guaranteed network; and,
a second session proxy device which is disposed between a server device not having said control protocol for bandwidth securing sessions installed therein and said bandwidth guaranteed network and which establishes a bandwidth securing session with said first session proxy device, in place of said server device when said server device performs communication with said client device over said bandwidth guaranteed network.

2. The session control system according to claim 1, wherein said first session proxy device, when receiving a connect request from said client device to said server device, checks a bandwidth to be secured for the communication required for said connect request and establishes a bandwidth securing session for securing the bandwidth.

3. The session control system according to claim 2, wherein said server device is an application server that provides a service having predetermined applications to said client device, and said first session proxy device, when receiving from said client device a connect request for receiving said application service from said server device, checks a bandwidth to be secured for the application communication based on the type of the application or the bandwidth information in said connect request, and establishes a bandwidth securing session for securing the bandwidth.

4. The session control system according to claim 3, wherein said first session proxy device has bandwidth management data that represents the correspondence between the types of applications and the bandwidths to be secured for communication of the applications, stored beforehand, and checks up the bandwidth to be secured for said application communication by referring to the bandwidth management data.

5. The session control system according to claim 3, wherein said first session proxy device checks up a bandwidth to be secured for the application communication by inquiring an application bandwidth that holds bandwidth management data representing the correspondence between the types of applications and the bandwidths to be secured for communication of the applications.

6. The session control system according to claim 1, wherein said first session proxy device, when receiving a connect request from said client device to said server device, establishes a bandwidth securing session with said second session proxy device while temporarily holding the connect request, and transmits said connect request to said bandwidth guaranteed network after securing the predetermined bandwidth.

7. The session control system according to claim 1, wherein, when said first session proxy device is informed of a disconnect request from said client device, transmits the disconnect request to said bandwidth guaranteed network, and releases said bandwidth securing session with said second session proxy device after reception of the response to the disconnect request.

8. A session proxy device which controls a bandwidth securing session on a bandwidth guaranteed network in which bandwidth-secured packet-based communication is enabled by management of the band securing session, comprising:
a proxy processor for monitoring an application signal sent from an information communicating device having no control protocol for bandwidth securing sessions installed therein to said bandwidth guaranteed network and detecting a connect request from the application signal; and
a session control protocol portion for establishing a bandwidth securing session inside said bandwidth guaranteed network in place of said information communicating device when said proxy processor detects said connect request.

9. The session proxy device according to claim 8, wherein when said proxy processor receives a connect request from said information communicating device, said session control protocol portion checks up a bandwidth to be secured for the communication required for the connect request and establishes a bandwidth securing session for securing the bandwidth.

10. The session proxy device according to claim 9, wherein said information communicating device is a client to be connected to an application server that provides a predetermined application service, and
when said proxy processor receives a connect request from said client for receiving the application service of said application server, said session control protocol portion checks a bandwidth to be secured for the application communication, based on the type of the application or the bandwidth information in said connect request and establishes a bandwidth securing session for securing the bandwidth.

11. The session proxy device according to claim 10, further comprising: a bandwidth information manager that has bandwidth management data representing the correspondence between the types of applications and the bandwidths to be secured for the application communication, stored beforehand,
wherein said session control protocol processor checks a bandwidth to be secured for the application communication by referring to said bandwidth management data.

12. The session proxy device according to claim 10, wherein said session control protocol processor checks a bandwidth to be secured for the application communication by inquiring an application bandwidth manager that holds bandwidth management data representing the correspondence between the types of applications and the bandwidths to be secured for said application communication.

13. The session proxy device according to claim 8, wherein said proxy processor, when receiving a connect request from said information communicating device, establishes said bandwidth securing session so as to secure the predetermined bandwidth while holding the connect request, and transmits the connect request to said bandwidth guaranteed network.

14. The session proxy device according to claim 8, wherein said proxy processor, when receiving a disconnect request from said information communicating device, transmits the disconnect request to said bandwidth guaranteed network, and releases said bandwidth securing session after reception of the response to the disconnect request.

15. A communication method for performing bandwidth secured communication in a bandwidth guaranteed network in which bandwidth-secured packet-based communication is enabled by management of a band securing session, comprising:
deploying a first session proxy device between a client device not having a control protocol for bandwidth securing sessions installed therein and said bandwidth guaranteed network and deploying a second session proxy device between a server device not having said control protocol installed therein and said bandwidth guaranteed network,
establishing a bandwidth securing session between the first session proxy device and the second session proxy device by said first session proxy device in place of said client device and by said second session proxy device in place of said server device; and
performing communication between said client device and said server device by way of said bandwidth guaranteed network.

16. A session control system which controls a bandwidth securing session on a bandwidth guaranteed network in which bandwidth-secured packet-based communication is enabled by management of the band securing session, comprising:
first session proxy means which is disposed between a client device not having a control protocol for bandwidth securing sessions installed therein and said bandwidth guaranteed network and which establishes a bandwidth securing session in said bandwidth guaranteed network, in place of said client device when said client device performs communication over said bandwidth guaranteed network; and,
second session proxy means which is disposed between a server device not having said control protocol for bandwidth securing sessions installed therein and said bandwidth guaranteed network and which establishes a bandwidth securing session with said first session proxy means, in place of said server device when said server device performs communication with said client device over said bandwidth guaranteed network.

17. A session proxy device which controls a bandwidth securing session on a bandwidth guaranteed network in which bandwidth-secured packet-based communication is enabled by management of the band securing session, comprising:
proxy processing means for monitoring an application signal sent from an information communicating device having no control protocol for bandwidth securing sessions installed therein to said bandwidth guaranteed network and detecting a connect request from the application signal; and
session control protocol means for establishing a bandwidth securing session inside said bandwidth guaranteed network in place of said information communicating device when said proxy processing means detects said connect request.
